(19) United States
(12) Patent Application Publication
(10) Pub. No.: US 2018/0150997 A1
(43) Pub. Date: May 31, 2018

(54) INTERACTION BETWEEN A TOUCH-SENSITIVE DEVICE AND A MIXED-REALITY DEVICE

(71) Applicant: Microsoft Technology Licensing, LLC, Redmond, WA (US)

(72) Inventor: Andrew Gerald Austin, Sherwood, OR (US)

(73) Assignee: Microsoft Technology Licensing, LLC, Redmond, WA (US)

(21) Appl. No.: 15/365,684

(22) Filed: Nov. 30, 2016

(51) Int. Cl. G06T 19/00; G06F 3/0346; G06F 3/0488; G06F 3/01; G06F 3/041; G06F 1/16

(52) U.S. Cl. CPC G06T 19/006; G06F 3/0346; G06F 3/04883; G06F 3/013; G06F 3/0482; G06F 3/0412; G06F 1/163; G06F 2203/04101; G06F 2203/04104; G06F 3/012

(57) ABSTRACT

A mixed-reality device includes a head-mounted display, a communication interface configured to wirelessly communicate with a remote touch-sensitive device, a logic machine, and a storage machine. The storage machine holds instructions executable by the logic machine to receive a pose of the touch-sensitive device in the physical space, receive, via the communication interface, a control signal that is based on a touch input to the touch-sensitive device, and in response to receiving the control signal, visually present, via the head-mounted display, a virtual object based on the pose of the touch-sensitive device.

### BRIEF DESCRIPTION OF THE DRAWINGS

FIG. 1 shows an example scenario in which a wearer of a mixed-reality device provides touch input to a touch-sensitive device positioned on a wall to control operation of the mixed-reality device.

FIGS. 2-3 show virtual objects visually presented by the mixed-reality device of FIG. 1 based on the touch input provided to the touch-sensitive device.

FIGS. 4-5 schematically show how the virtual object of FIGS. 2-3 change virtual positions based on the touch input provided to the touch-sensitive device.

FIGS. 6-7 show the virtual objects of FIGS. 2-3 undergoing various changes in appearance based on recognized touch input gestures provided to the touch-sensitive device.

FIG. 8 shows an example scenario in which operation of a mixed-reality device is controlled based on touch input provided to a touch-sensitive device by a user other than a wearer of the mixed-reality device.

FIGS. 9-10 show virtual objects visually presented by the mixed-reality device of FIG. 8 based on the touch input provided to the touch-sensitive device by the other user.

FIG. 11 shows an example scenario in which operation of a mixed-reality device is controlled based on touch input provided to a touch-sensitive device by both a wearer of the mixed-reality device and a user other than the wearer.

FIG. 12 shows virtual objects visually presented by the mixed-reality device of FIG. 11 based on the touch input provided to the touch-sensitive device by the wearer and the other user.

FIG. 13 shows an example scenario in which a wearer of a mixed-reality device provides touch input to a touch-sensitive display to control operation of the mixed-reality device.

FIG. 14 shows virtual objects visually presented by the mixed-reality device of FIG. 13 based on the touch input provided to the touch-sensitive display.

FIG. 15 shows an example method for controlling operation of a mixed-reality device based on touch input to a remote touch-sensitive device.

FIG. 16 shows an example head-mounted, mixed-reality device.

FIG. 17 shows an example computing system.

### DETAILED DESCRIPTION

A mixed-reality experience virtually simulates a three-dimensional imagined or real world in conjunction with real-world movement. In one example, a mixed-reality experience is provided to a user by a computing system that visually presents virtual objects to the wearer's eye(s) via a head-mounted, near-eye display. The head-mounted, near-eye display allows the wearer to use real-world motion in order to interact with a virtual simulation. In such a configuration, virtual objects may be visually presented to the wearer via the head-mounted, near-eye display. However, if the wearer attempts to touch the virtual objects, there is no tactile feedback. The lack of tactile feedback associated with the virtual object may make the mixed-reality experience less immersive and intuitive for the user.

Accordingly, the present description is directed to an approach for controlling a mixed-reality device to present a mixed-reality experience in which the wearer of the mixed-reality device may have tactile feedback based on interaction with a virtual object visually presented by the mixed-reality device. Such a configuration may be realized by controlling the mixed-reality device based on user interaction with a remote touch-sensitive device that is in communication with the mixed-reality device. More particularly, the mixed-reality device may be configured to visually present a virtual object in response to receiving, from a touch-sensitive device, a control signal that is based on a touch input to the touch-sensitive device. Further, the mixed-reality device may visually present the virtual object based on the pose of the touch-sensitive device. For example, the mixed-reality device may visually present the virtual object to appear on a surface of the touch-sensitive device. By visually presenting virtual objects in this manner, a wearer of the mixed-reality device may be provided with tactile feedback when interacting with a mixed-reality experience including virtual object visually presented by the mixed-reality device.

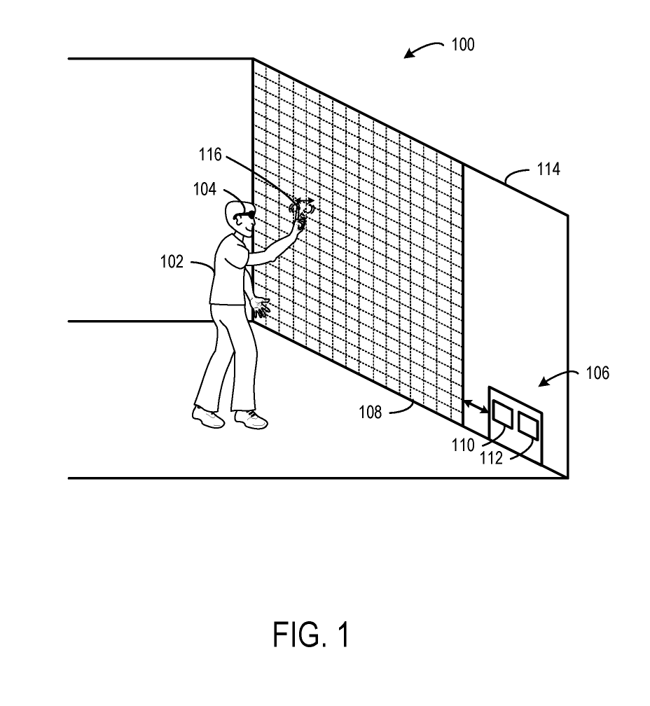

FIGS. 1-3 show an example physical space 100 in which a user (or wearer) 102 is wearing a mixed-reality device 104 in the form of a head-mounted, see-through display device and interacting with a touch-sensitive device 106. The touch-sensitive device 106 includes a touch sensor 108, touch logic 110, and a communication interface 112.

The touch sensor 108 is mounted to a wall 114 in the physical space 100. The touch sensor 108 is configured to sense one or more sources of touch input. In the depicted scenario, the wearer 102 is providing touch input to the touch sensor 108 via a finger 116. Further, the touch sensor 108 may be configured to sense touch input supplied by various touch input devices, such as an active stylus. The finger 116 of the wearer 102 and the active stylus are provided as non-limiting examples, and any other suitable source of passive and active touch input may be used in connection with the touch sensor 108. “Touch input” as used herein refers to input from a source that contacts the touch sensor 108 as well as input from a source that “hovers” proximate to the touch sensor 108. In some implementations, the touch sensor 108 may be configured to receive input from two or more sources simultaneously, in which case the touch-sensitive device 106 may be referred to as a multi-touch device. In some such implementations, the touch-sensitive device 106 may be configured to identify and differentiate touch input provided by different touch sources (e.g., different active styluses, touch input provided by different users in the physical space).

The touch sensor 108 may employ any suitable touch sensing technology including one or more of conductive, resistive, and optical touch sensing technologies. In one example, the touch sensor 108 includes an electrode matrix that is embedded in a material that facilitates coupling of the touch sensor 108 to the wall 114. Non-limiting examples of such material include paper, plastic or other polymers, and glass. For example, such a touch sensor 108 may be applied to the wall 114 via an adhesive similar in a manner to adhering wallpaper on a wall.

The touch sensor 108 may have any suitable dimensions, such that the touch sensor 108 may cover any suitable portion of the wall 114. In some implementations, the touch sensor 108 may be applied to other surfaces in the physical space 100, such as table tops, doors, and windows. In some implementations, the touch sensor 108 may be applied to a surface of a movable object that can change a pose in the physical space 100.

The touch sensor 108 is operatively coupled to the touch logic 110 such that the touch logic 110 receives touch input data from the touch sensor 108. The touch logic 110 is configured to process and interpret the touch input data, with the aim of identifying and localizing touch events performed on the touch sensor 108. Further, the touch logic 110 is configured to generate control signals from the touch input data and/or the touch events. The control signals may include any suitable touch input information. For example, the control signals may include a position of touch events on the touch sensor 108. In some implementations, the touch logic 110 may be configured to perform higher-level processing on the touch input data to recognize touch input gestures. In such implementations, the touch logic 110 may be configured to generate control signals from the recognized touch input gestures.

The communication interface 112 is configured to communicate with the mixed-reality device 104. In particular, the communication interface 112 is configured to send control signals generated based on touch input to the touch sensor 108 to the mixed-reality device. The communication interface 112 may include any suitable communication componentry including wired and/or wireless communication devices compatible with one or more different communication protocols/standards (e.g., Wi-Fi, Bluetooth).

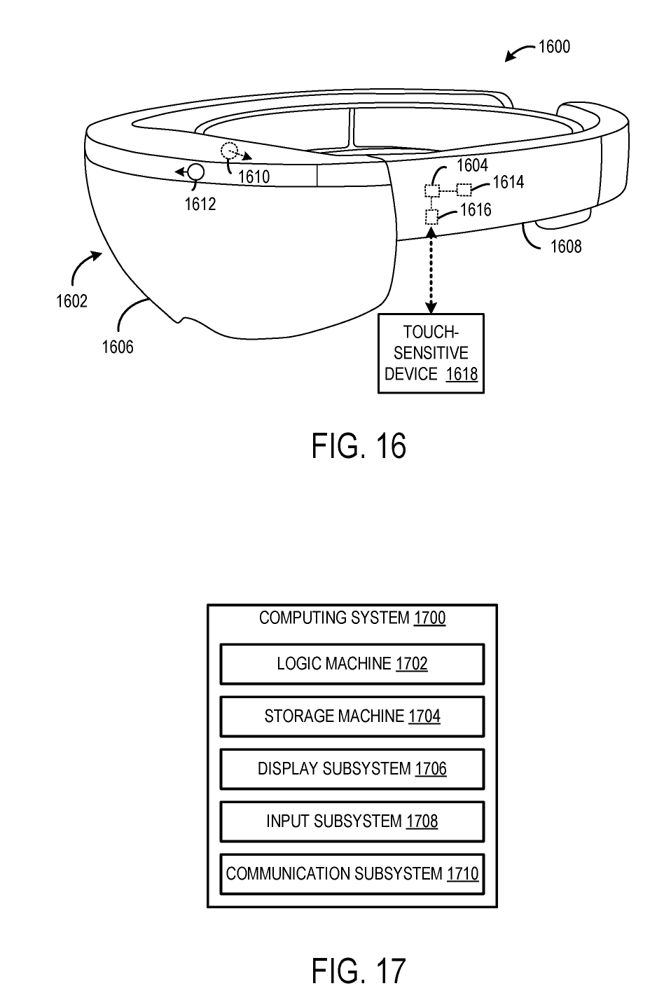

The touch-sensitive device 106 may be spatially registered with the mixed-reality device 104 in the physical space 100. For example, the touch-sensitive device 106 may be spatially registered with the touch-sensitive device 106 by determining a pose (e.g., position and/or orientation in up to six degrees of freedom) of the mixed-reality device 104 as well as a pose of the touch-sensitive device 106. The mixed-reality device 104 may be configured to receive the pose of the touch-sensitive device 106 from any suitable source, in any suitable manner. In one example, the mixed-reality device 104 receives the pose of the touch-sensitive device 106 from the touch-sensitive device 106. In another example, the mixed-reality device 104 includes componentry configured to determine the pose of the touch-sensitive device 106 and the pose is received from such componentry. Such componentry is discussed below with reference to FIG. 16. In another example, the mixed-reality device 104 receives the pose of the touch-sensitive device 106 from another device, such as a device configured to generate a computer-model of the physical space 100.

The mixed-reality device 104 is configured to, in response to receiving one or more control signals that are based on touch input to the touch-sensitive device 106, visually present one or more virtual objects based on the pose of the touch-sensitive device 106. The virtual objects may be visually presented such that the visual objects may have any suitable spatial relationship with the pose of the touch-sensitive device 106. In other words, a size and position of the virtual objects on the display of the mixed-reality device 104 is determined in relation to the pose of the touch-sensitive device 106. For example, the virtual objects may be visually presented at a lesser depth, a greater depth, or at a same depth as the pose of the touch-sensitive device. Further, the virtual objects may be offset or positioned in relation to other axes of the pose besides depth.

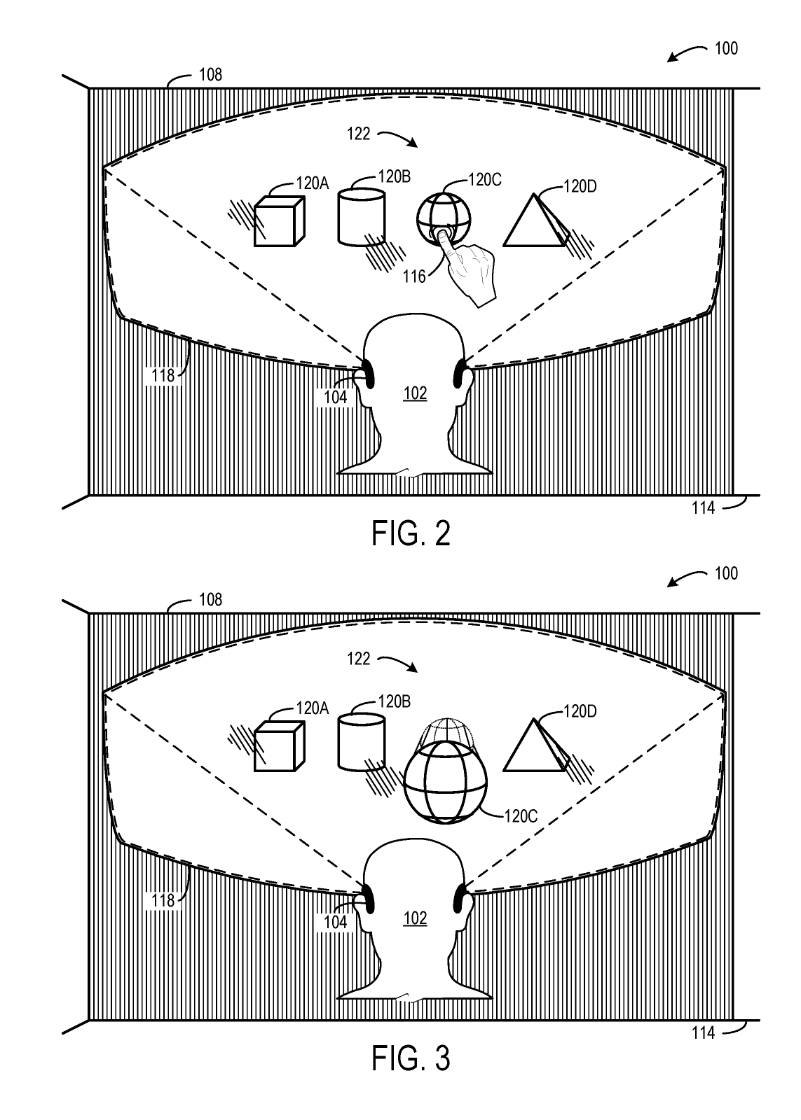

FIGS. 2-3 depict an example scenario in which the mixed-reality device 104 visually presents mixed-reality images including virtual objects based on touch input provided by the wearer 102 to the touch-sensitive device 106. The mixed-reality device 104 enables the wearer 102 to virtually manipulate the virtual objects based on touch input to the touch-sensitive device 106.

The mixed-reality device 104 provides the wearer 102 with a see-through field of view (FOV) 118 of the physical space 100. Because the mixed-reality device 104 is mounted on the wearer's head, the FOV 118 of the physical space 100 may change as a pose of the wearer's head changes.

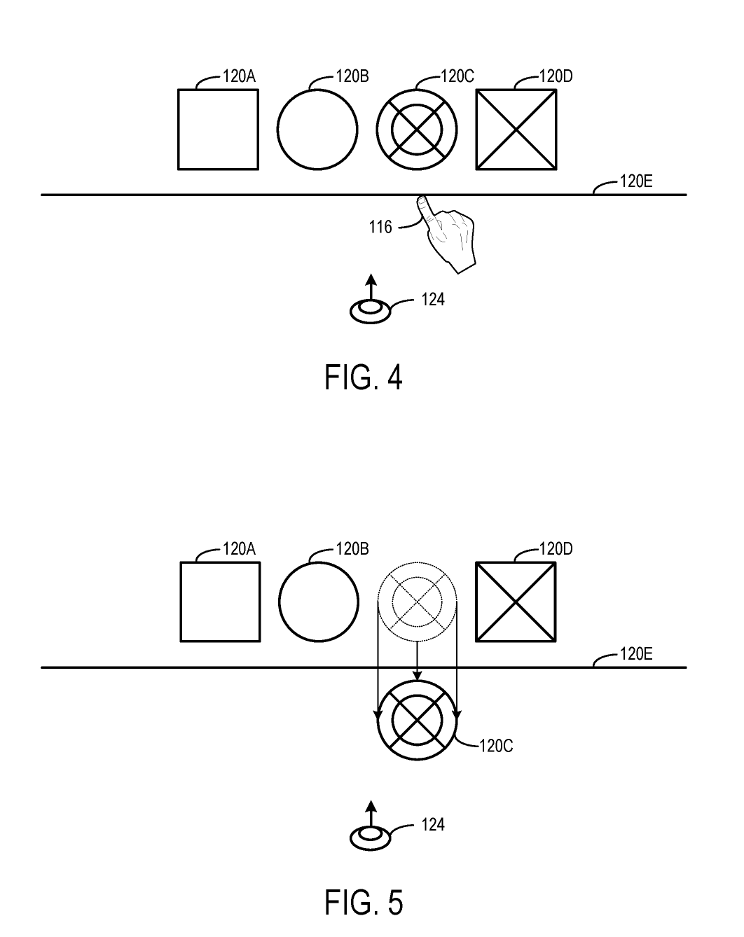

In this scenario, the wearer 102 is looking at the wall 114, which appears opaque outside of the field of view 118. Inside the field of view 118, the mixed-reality device 104 visually presents a plurality of virtual objects 120 (e.g., 120A, 120B, 120C, 120D, 120E) that collectively form a mixed-reality image 122. In particular, a cube 120A, a cylinder 120B, a sphere 120C, and a pyramid 120D appear to be positioned behind a transparent glass panel 120E (shown in FIG. 4). In particular, the transparent glass panel 120E may be visually presented to have a perceived depth that is the same as the perceived depth of the touch sensor 108/wall 114. In other words, the mixed-reality device 104 uses the pose of the touch sensor 108 to generate the mixed-reality image 122 including appropriately positioning the plurality of virtual objects 120 based on the pose. As shown in FIG. 4, the plurality of virtual objects 120A-D have virtual positions with a perceived depth greater than a perceived depth of the glass panel 120E relative to the wearer's perspective 124.

As shown in FIGS. 2 and 4, the wearer 102 touches the touch sensor 108 with the finger 116 at a position that aligns with the sphere 120C. This mixed-reality interaction may be perceived by the wearer 102 as tapping on the glass panel 120E to select the sphere 120C. Because the glass panel 120E has a depth that is the same as the touch sensor 108/wall 114, the wearer 102 may receive tactile feedback from physically touching the wall 114 when selecting the sphere 120C. When the wearer 102 touches the touch sensor 108, the touch sensor 108 detects the touch input and the touch-sensitive device 106 sends a control signal that is based on the touch input to the mixed-reality device 104.

In some implementations, the touch sensor 108 may include haptic feedback components configured to provide haptic feedback based on detecting touch input to the touch sensor. In one example, when the wearer 102 provides touch input to the touch sensor 108, the touch sensor 108 momentarily vibrates at the position of the touch input to indicate to the wearer 102 that touch input occurred. In such an implementation, the wearer 102 may be provided with tactile feedback that includes haptic feedback.

As shown in FIGS. 3 and 5, in response to receiving the control signal from the touch-sensitive device 106, the mixed-reality device 104 visually presents the sphere 120C at a second perceived depth that is less than the perceived depth of the other virtual objects 120A, 120B, and 120D. In particular, the sphere 120C moves toward the wearer's perspective 124, such that the sphere 120C appear to be positioned in front of the glass panel 120E.

The arrangement of the plurality of virtual objects 120 is meant to be non-limiting. Although the plurality of virtual objects 120 are described as being visually presented as having the same depth, it will be appreciated that the plurality of virtual objects 120 may be visually presented in any suitable arrangement. Further, each of the plurality of virtual objects 120 may be positioned at any suitable depth relative to the depth/pose of the touch sensor 108. In another example, different virtual objects may be visually presented at different depths, and when a virtual object is selected, that virtual object may be visually presented at a depth different than a depth of any of the other virtual objects. In another example, the plurality of virtual objects may be positioned at depths less than the depth of the touch sensor 108, and when a virtual object is selected, that virtual object may be visually presented at the depth of the touch sensor 108—e.g., the selected virtual object may “snap” to the touch sensor 108. In another example, the wearer 102 may perform a gesture that is detected by the mixed-reality device 104 without providing touch input to the touch-sensor to select the virtual object.

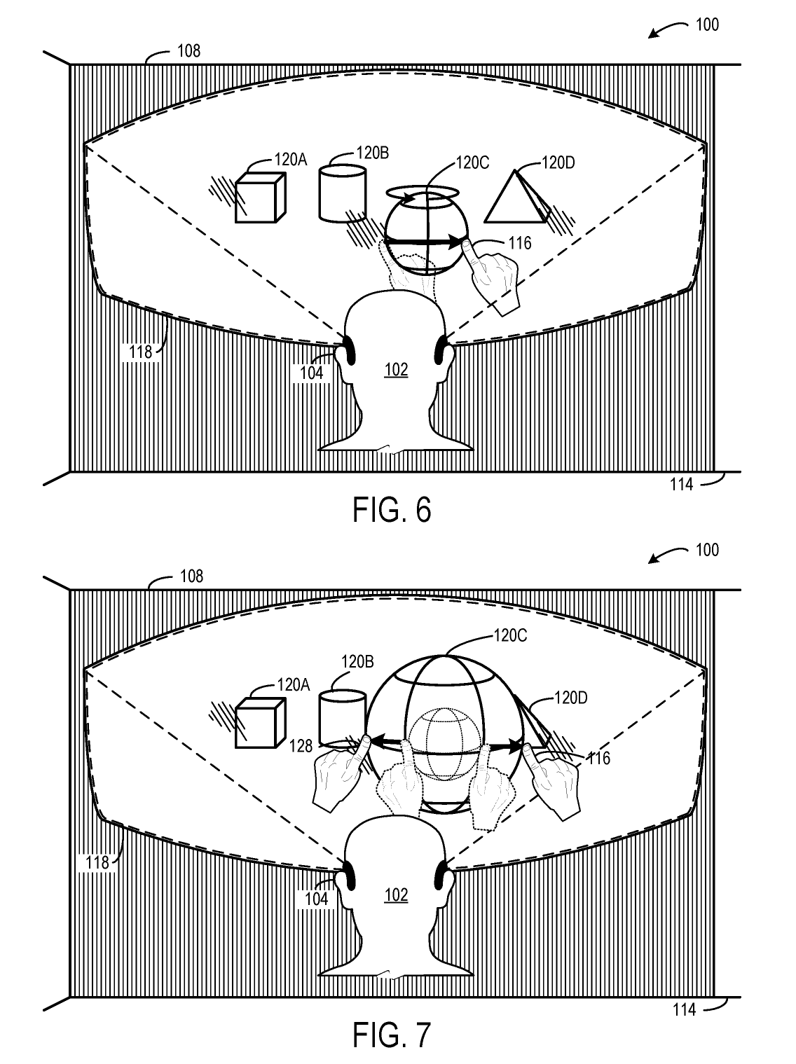

Once the sphere 120C is selected from the plurality of virtual objects 120, the wearer 102 can manipulate the sphere 120C or change the appearance of the sphere 120C based on further touch input to the touch sensor 108. FIGS. 6 and 7 shows example manipulations or changes of the appearance of the sphere 120C based on further touch input provided by the wearer 102 to the touch sensor 108.

As shown in FIG. 6, the wearer 102 touches the touch sensor 108 with the finger 116 at a position that aligns with the left side of the sphere 120C. The wearer 102 proceeds to move the finger 116 from left to right along the touch sensor 108 a distance approximate to the perceived width of the sphere 120C. Such touch input may be identified as a swipe gesture that is aligned with the sphere 120C. The touch-sensitive device 106 sends control signals to the mixed-reality device 104 based on the touch input. In some implementations, the touch-sensitive device 106 may identify the swipe gesture from the touch input and send control signals that are based on the swipe gesture to the mixed-reality device. In some implementations, the mixed-reality device 104 may be configured to identify the swipe gesture based on the control signals received from the touch-sensitive device 106. In response to receiving the control signals, the mixed-reality device 104 changes the appearance of the sphere 120C by visually presenting the sphere 120C as rotating counterclockwise based on the swipe gesture.

As shown in FIG. 7, the wearer 102 touches the touch sensor 108 with the right finger 116 at a right-side position of the sphere 120C and the left finger 128 at a left-side position of the sphere 120C. The wearer 102 proceeds to move the right finger 116 and the left finger 128 farther apart from each other along the touch sensor 108. Such touch input may be identified as a multi-finger enlargement gesture. The touch-sensitive device 106 sends control signals to the mixed-reality device 104 based on the touch input. In response to receiving the control signals, the mixed-reality device 104 changes the appearance of the sphere 120C by visually presenting the sphere 120C with increased size based on the enlargement gesture.

The example scenarios depicted in FIGS. 6 and 7 are meant to be non-limiting. The mixed-reality device 104 is configured to change an appearance or otherwise manipulate visual presentation of a virtual object in any suitable manner based on any suitable touch input. In one example, the wearer 102 may provide touch input to the touch sensor 108 to move the sphere 120C to a different location. In another example, the wearer 102 may provide touch input to the touch sensor 108 to change a color or other parameter of the sphere 120C. In yet another example, the wearer 102 may provide touch input to the touch sensor 108 to deselect the sphere 120C that would cause the sphere 120C to move back to a position that appears behind the glass panel 120E. In yet another example, when a virtual object is selected, that virtual object may be visually presented and the other virtual objects may not be visually presented for as long as that virtual object is selected. When the virtual object is deselected (e.g., by double tapping the touch sensor 108), the virtual object may return to the depth at which it was previously visually presented (e.g., aligned with the other virtual objects). Additionally, the other virtual objects again may be visually presented when the virtual object is deselected.

Although the manipulations described above are based on touch input that is aligned with the selected virtual object, it will be appreciated that in some cases that wearer may provide touch input to a region of the touch sensor 108 that is not perceived as being “on” the virtual object to change the appearance of the virtual object.

In some implementations, a selected virtual object may be manipulated or an appearance of the selected virtual object may be changed based on gestures performed by the wearer without providing touch input to the touch sensor 108. In such an example, the wearer 102 may perform a gesture that is detected by the mixed-reality device 104, such as via an optical system of the mixed-reality device 104.

In the above-described scenarios, the coordinated operation between the mixed-reality device 104 and the touch-sensitive device 106 provides a mixed-reality experience in which the wearer 102 receives tactile feedback via the touch-sensitive device 106 based on interacting with virtual objects visually presented by the mixed-reality device.

Although the touch sensor 108 is depicted as being located only on the wall 114 in FIG. 1, it will be appreciated that the touch sensor 108 may be applied to or positioned on a plurality of different walls in the physical space 100 as well as on other surfaces and objects in the physical space 100. In one example, the touch sensor 108 is positioned on every wall. In another example, the touch sensor 108 is positioned on a wall and a surface of a table. In yet another example, the touch sensor 108 is positioned on a sphere that surrounds the wearer 102 such that the wearer has a 3600 interaction space. In yet another example, the touch sensor 108 is applied to the surface of a prototype or mockup of a product in development. In such an example, the finished product can be virtually applied to the prototype via the mixed-reality device 104, and the wearer 102 can virtually interact with the finished product by touching the prototype.

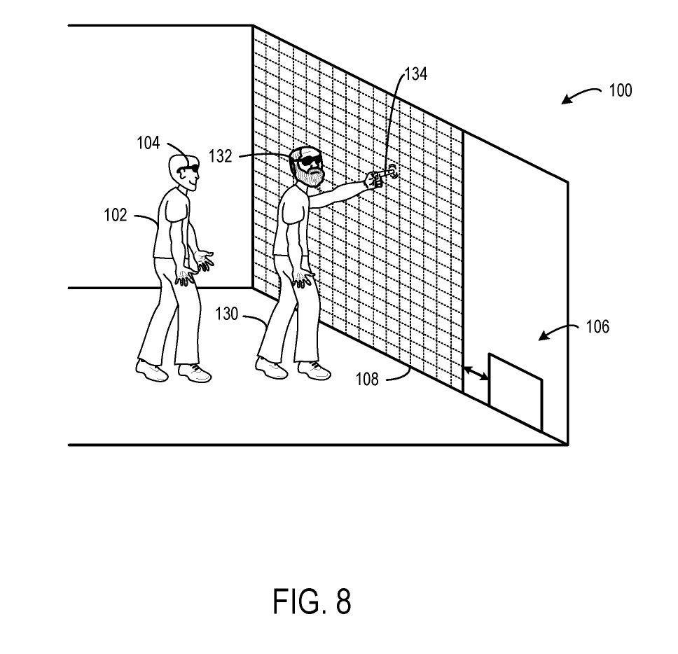

In some implementations, the mixed-reality device 104 may be configured to visually present virtual objects based on receiving, from a touch-sensitive device, control signals that are based on touch input by a user other than the wearer of the mixed-reality device. FIGS. 8-10 show an example scenario in which a mixed-reality device visually presents a virtual object based on touch input provided by another user. As shown in FIG. 8, the wearer 102 and another user 130 are interacting with the touch-sensitive device 106 in the physical space 100. The other user 130 is wearing a mixed-reality device 132 that operates in the same manner as the mixed-reality device 104. In particular, the other user 130 is providing touch input to the touch sensor 108 via a finger 134 and the wearer 102 is observing the other user 130.

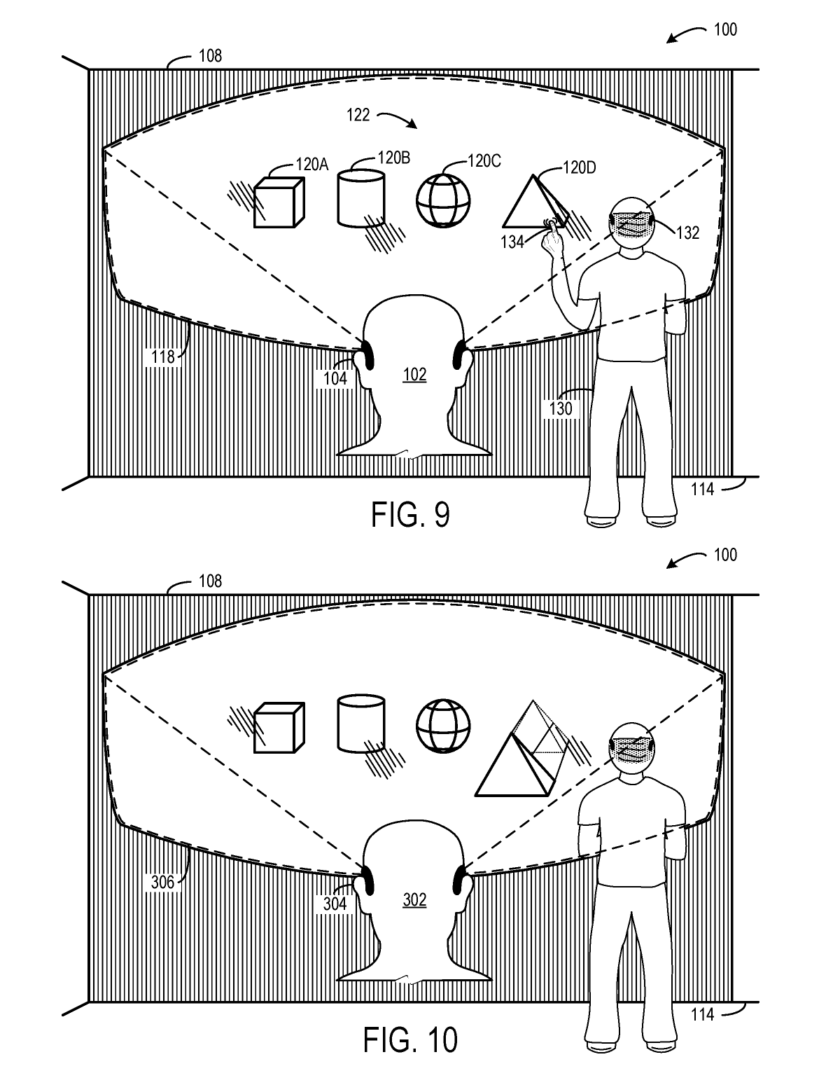

As shown in FIG. 9, in this scenario, inside the field of view 118, the mixed-reality device 104 visually presents the cube 120A, the cylinder 120B, the sphere 120C, and the pyramid 120D behind a transparent glass panel 120E (shown in FIGS. 4 and 5). The other user 130 touches the touch sensor 108 with the finger 134 at a position that aligns with the pyramid 120D. When the wearer 102 touches the touch sensor 108, the touch sensor 108 detects the touch input and the touch-sensitive device 106 sends a control signal that is based on the touch input to the mixed-reality device 104. The touch-sensitive device 106 further may send the control signal to the mixed-reality device 132.

As shown in FIG. 10, in response to receiving the control signal from the touch-sensitive device 106, the mixed-reality device 104 visually presents the pyramid 120D at a second perceived depth that is less than the perceived depth of the other virtual objects 120A, 120B, and 120C. In particular, the pyramid 120D moves toward the wearer's perspective, such that the pyramid appears to be positioned in front of the glass panel 120E (shown in FIGS. 4 and 5). The wearer 102 and/or the other user 130 may provide subsequent touch input to the touch sensor 108 to change the appearance of the pyramid 120D.

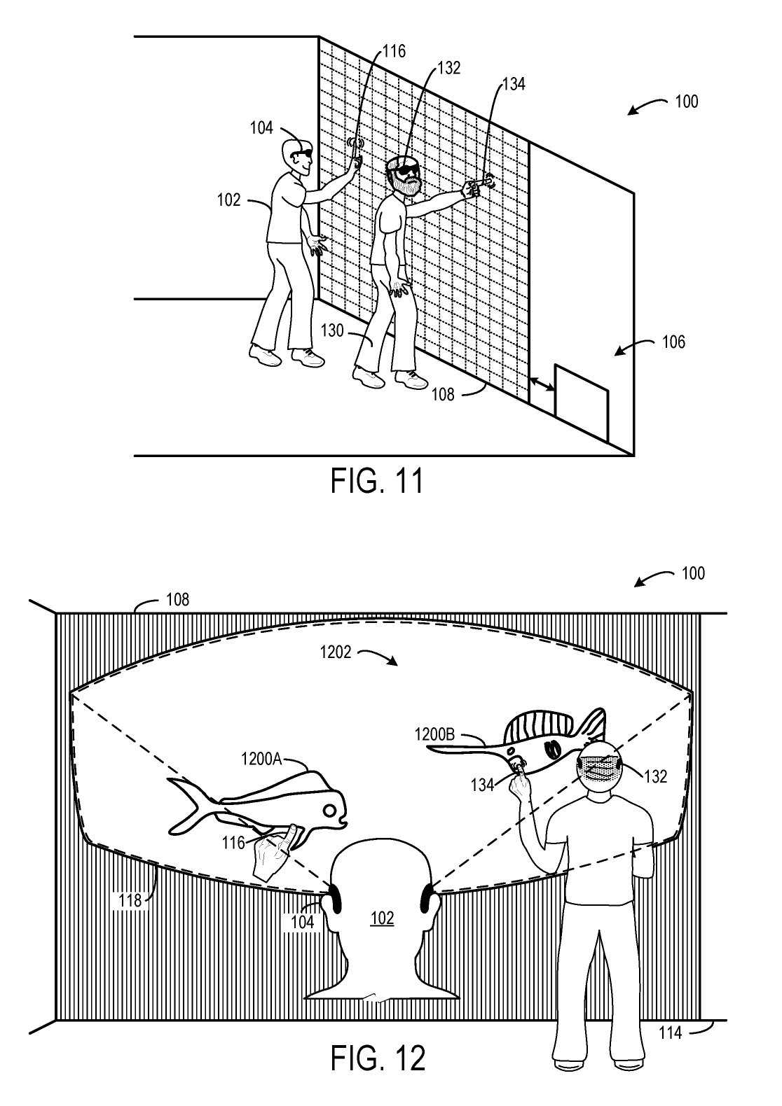

FIGS. 11-12 show an example scenario in which a mixed-reality device visually presents a plurality of virtual objects based on touch input provided by a wearer of the mixed-reality device as well as another user. As shown in FIG. 11, the wearer 102 and another user 130 are interacting with the touch-sensitive device 106 in the physical space 100. The other user 130 is wearing a mixed-reality device 132 that operates in the same manner as the mixed-reality device 104. In particular, the wearer 102 is providing touch input to the touch sensor 108 at a first position via the finger 116. Meanwhile, the other user 130 is providing touch input to the touch sensor 108 at a second position via the finger 134.

As shown in FIG. 12, in this scenario, inside the field of view 118, the mixed-reality device 104 visually presents a plurality of virtual objects 1200 (e.g., 1200A and 1200B) that collectively form a mixed-reality image 1202. In particular, the mixed-reality device visually presents a drawing of a Dorado fish 1200A based on receiving, from the touch-sensitive device 106, control signals that are based on touch input provided at the first position of the touch sensor 108 by the finger 116 of the wearer 102. Further, the mixed-reality device 104 visually presents a drawing of a sail fish 1200B based on receiving, from the touch-sensitive device 106, control signals that are based on touch input provided at the second position of the touch sensor 108 by the finger 134 of the other user 130. The mixed-reality device 104 visually presents the plurality of virtual objects 1200 with a perceived depth that is the same as the perceived depth of the touch sensor 108/wall 114 from the perspective of the wearer 102.

Furthermore, the mixed-reality device 132 visually presents the plurality of virtual objects 1200 with a perceived depth that is the same as the perceived depth of the touch sensor 108/wall 114 from the perspective of the other user 130. In other words, the different mixed-reality device 104 and 132 visually present the plurality of virtual objects 1200 differently based on the different poses of the mixed-reality devices 104 and 132. In each case, the plurality of virtual objects 1200 are aligned with pose of the touch sensor 108 from each perspective even though the wearer 102 and the other user 130 have different poses in the physical space 100. By placing the plurality of virtual objects 1200 at the depth of the touch sensor 108/wall 114 from the perspective of the wearer 102 and the other user 130 respectively, the plurality of virtual objects 1200 may be perceived as being drawn on a surface based on receiving tactile feedback from the touch sensor 108/wall 114.

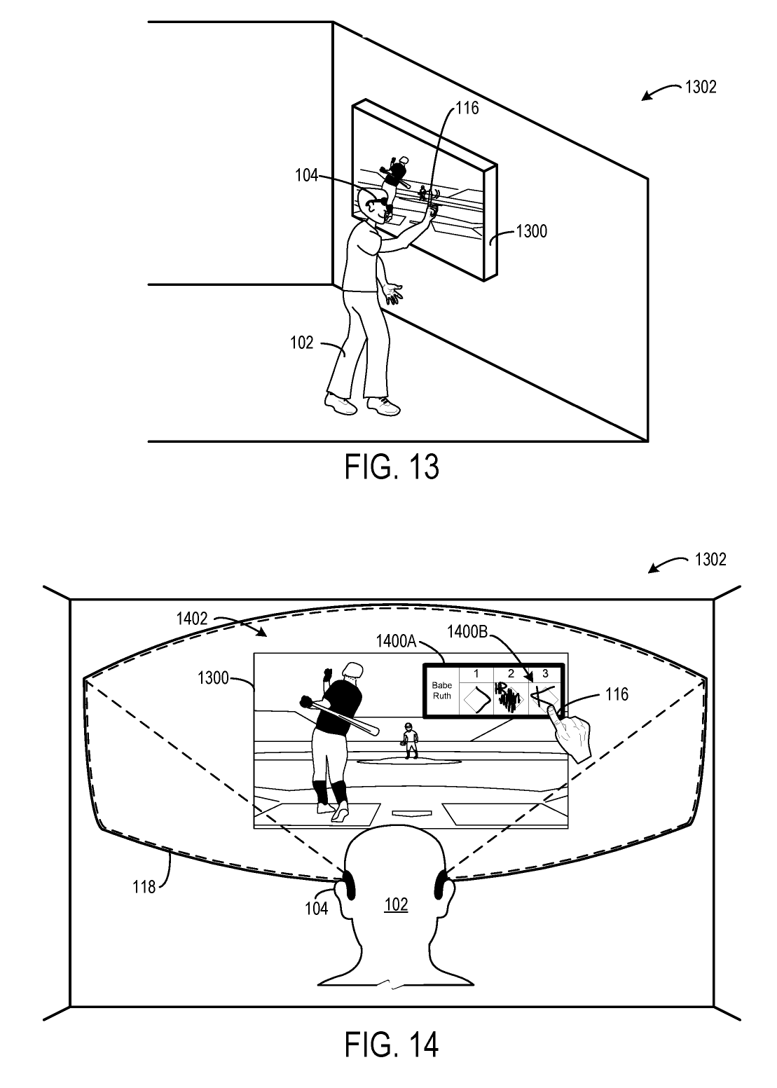

In the above-described scenarios, the touch-sensitive device is described in terms of being a wall-mounted touch sensor. It will be appreciated that the concepts described herein may be broadly applicable to any suitable touch-sensitive device. FIGS. 13-14 show an example scenario in which a mixed-reality device visually presents a plurality of virtual objects based on touch input provided by a wearer of the mixed-reality device to a touch-sensitive display device. As shown in FIG. 13, the wearer 102 is interacting with a touch-sensitive display device 1300 in a physical space 1302. In particular, the wearer 102 is watching a baseball game that is visually presented by the touch-sensitive display device 1300. Meanwhile, the wearer 102 is providing touch input to the touch-sensitive display device 1300 via the finger 116.

As shown in FIG. 14, in this scenario, inside the field of view 118, the mixed-reality device 104 visually presents a plurality of virtual objects 1200 (e.g., 1400A and 1400B) that collectively form a mixed-reality image 1402. In particular, the mixed-reality device 104 visually presents a virtual box score 1400A and drawing annotations 1400B based on receiving, from the touch-sensitive display device 1300, control signals that are based on touch input provided to the touch-sensitive display device 1300 by the finger 116 of the wearer 102. The mixed-reality device 104 is configured to visually present the virtual box score 1400A based on the pose of the touch-sensitive display device 1300. For example, the virtual box score 1400A may be positioned such that the virtual box score 1400A appears integrated into the broadcast of the baseball game. In this scenario, the wearer 102 is able to watch the baseball game on the touch-sensitive display device 1300 while filling out the virtual box score 1400A with the drawing annotations 1400B as plays happen during the game. In one example, when the wearer 102 provides touch input to the touch-sensitive display device 1300, the touch-sensitive display device 1300 provides haptic feedback (e.g., a vibration at the touch position) to indicate to the wearer 102 that touch input occurred on the touch-sensitive display device 1300.

In one example, the mixed-reality device 104 visually presents the virtual box score 1400A in response to the wearer providing touch input to the touch-sensitive display device 1300, and stops presenting the virtual box score 1400A when the wearer 102 stops providing touch input to the touch-sensitive display device 1300. Such functionality may provide the wearer with an “on-demand” view of the virtual box score 1400A as desired.

In some implementations, the mixed-reality device 104 may be configured to identify an object visually presented by the touch-sensitive display device 1300, and visually present a virtual object based on the identified object. In some such implementations, the mixed-reality device 104 may include an optical tracking system including an outward facing camera that may be configured to identify objects in the physical space 1302 including objects displayed by the touch-sensitive display device 1300. In other such implementations, the touch-sensitive display device 1300 may send, to the mixed-reality device 104, information that characterizes what is being visually presented by the touch-sensitive display device 1300 including such objects.

In some cases, the mixed-reality device 104 may visually present the virtual object based on the position of the identified object. For example, the mixed-reality device 104 may identify a position of the baseball players in the baseball game visually presented by the touch-sensitive display device 1300 and visually present the virtual box score 1400A in a position on the touch-sensitive display device 1300 that occlude the baseball players from the perspective of the wearer 102.

In some cases, the virtual object may be visually presented based on a characteristics of an identified object. For example, the mixed-reality device 104 may identify a color scheme (e.g., team colors)/keywords (e.g., team/player names) in the baseball game visually presented by the touch-sensitive display device 1300. Further, the mixed-reality device 104 may visually present the virtual box score 1400A populated with player names based on identifying the team and/or with colors corresponding to the teams. The mixed-reality device 104 may be configured to visually present any suitable virtual object based on any suitable parameter of an object identified as being visually presented by a touch-sensitive device.

In the above-described scenario, the touch-sensitive display device 1300 is mounted to a wall such that it has a fixed pose in the physical space 1302. The concepts described herein are applicable to a mobile touch-sensitive display device that has a pose that changes relative to the mixed-reality device. For example, the mixed-reality device may visually presented virtual object based on receiving control signals that are based on touch input to a smartphone, tablet, laptop, or other mobile computing device having touch-sensing capabilities. In such implementations, the pose of the mobile touch-sensitive display device may be determined in any suitable manner. In one example, the mixed-reality device includes an optical tracking system including an outward facing camera configured to identify the pose of the mobile touch-sensitive display device. In another example, the mobile touch-sensitive display device sends, to the mixed-reality device, information that characterizes the pose of the mobile touch-sensitive display device.

Furthermore, the concepts described herein are applicable to mobile touch-sensitive devices without display functionality. For example, a physical space may include a plurality of different physical objects at least partially covered by different touch sensors that are in communication with the mixed-reality device. The wearer may pick up and move any of the different physical objects, such touch input may be reported by the touch sensors to the mixed-reality device, and the mixed-reality device may visually present virtual objects based on the pose of the different physical objects. For example, the mixed-reality device may overlay different surfaces on the different physical objects.

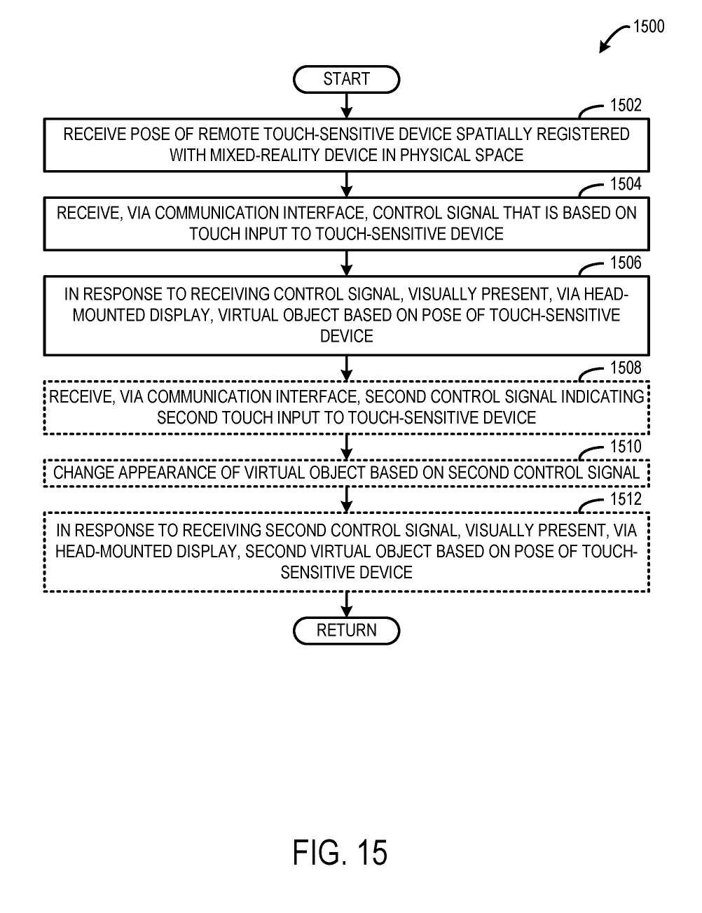

FIG. 15 shows an example method 1500 for controlling operation of a mixed-reality device based on touch input to a remote touch-sensitive device. For example, the method may be performed by the mixed-reality device 104 of FIG. 1, the mixed-reality device 132 of FIG. 8, the mixed-reality computing system 1600 of FIG. 16, and the computing system 1700 of FIG. 17. At 1502, the method 1500 includes receiving a pose of a remote touch-sensitive device spatially registered with a mixed-reality device in a physical space. At 1504, the method 1500 includes receiving, via a communication interface of the mixed-reality device, a control signal that is based on a touch input to the touch-sensitive device. For example, the control signal may include one or more parameters of the touch input including a position, a pressure, a user/device that performed the touch input, and a gesture. The control signal may convey any suitable information about the touch input to the mixed-reality device. At 1506, the method 1500 includes in response to receiving the control signal, visually presenting, via a head-mounted display of the mixed-reality device, a virtual object based on the pose of the touch-sensitive device. For example, the virtual object may be positioned to appear in alignment with a surface of the touch-sensitive device.

In some implementations, at 1508, the method 1500 optionally may include receiving, via a communication interface, a second control signal that is based on a second touch input to the touch-sensitive device. The second touch input may be provided by the wearer of the mixed-reality device or another user in the physical space. At 1510, the method 1500 optionally may include in response to receiving the second control signal, changing an appearance of the virtual object based on the second control signal. For example, changing the appearance of the virtual object may include one or more of changing a size, changing a position, and changing an orientation of the virtual object. In some implementations, the appearance of the virtual object may be changed based on a touch input gesture as described in the example scenarios of FIGS. 6 and 7. At 1512, the method 1500 optionally may include in response to receiving the second control signal, visually presenting, via the head-mounted display, a second virtual object based on the pose of the touch-sensitive device. Different touch inputs may cause different virtual objects to be visually presented with different poses as described in the example scenarios of FIGS. 12 and 14.

The coordinated operation between the mixed-reality device and the touch-sensitive device provides a mixed-reality experience in which the wearer receives tactile feedback via the touch-sensitive device based on interacting with virtual objects visually presented by the mixed-reality device.

FIG. 16 shows aspects of an example mixed-reality computing system 1600 including a near-eye display 1602. The mixed-reality computing system 1600 is a non-limiting example of the mixed-reality device 104 shown in FIG. 1, the mixed-reality device 132 shown in FIG. 8 and/or the computing system 1700 shown in FIG. 17.

The mixed-reality computing system 1600 may be configured to present any suitable type of mixed-reality experience. In some implementations, the mixed-reality experience includes a totally virtual experience in which the near-eye display 1602 is opaque, such that the wearer is completely absorbed in the virtual-reality imagery provided via the near-eye display 1602.

In some implementations, the mixed-reality experience includes an augmented-reality experience in which the near-eye display 1602 is wholly or partially transparent from the perspective of the wearer, to give the wearer a clear view of a surrounding physical space. In such a configuration, the near-eye display 1602 is configured to direct display light to the user's eye(s) so that the user will see augmented-reality objects that are not actually present in the physical space. In other words, the near-eye display 1602 may direct display light to the user's eye(s) while light from the physical space passes through the near-eye display 1602 to the user's eye(s). As such, the user's eye(s) simultaneously receive light from the physical environment and display light.

In such augmented-reality implementations, the mixed-reality computing system 1600 may be configured to visually present augmented-reality objects that appear body-locked and/or world-locked. A body-locked augmented-reality object may appear to move along with a perspective of the user as a pose (e.g., 6 degrees of freedom (DOF): x, y, z, yaw, pitch, roll) of the mixed-reality computing system 1600 changes. As such, a body-locked, augmented-reality object may appear to occupy the same portion of the near-eye display 1602 and may appear to be at the same distance from the user, even as the user moves in the physical space. On the other hand, a world-locked, augmented-reality object may appear to remain in a fixed location in the physical space, even as the pose of the mixed-reality computing system 1600 changes.

In some implementations, the opacity of the near-eye display 1602 is controllable dynamically via a dimming filter. A substantially see-through display, accordingly, may be switched to full opacity for a fully immersive virtual-reality experience.

The mixed-reality computing system 1600 may take any other suitable form in which a transparent, semi-transparent, and/or non-transparent display is supported in front of a viewer's eye(s). Further, implementations described herein may be used with any other suitable computing device, including but not limited to mobile computing devices, laptop computers, desktop computers, tablet computers, other wearable computers, etc.

Any suitable mechanism may be used to display images via the near-eye display 1602. For example, the near-eye display 1602 may include image-producing elements located within lenses 1606. As another example, the near-eye display 1602 may include a display device, such as a liquid crystal on silicon (LCOS) device or OLED microdisplay located within a frame 1608. In this example, the lenses 1606 may serve as, or otherwise include, a light guide for delivering light from the display device to the eyes of a wearer. Additionally or alternatively, the near-eye display 1602 may present left-eye and right-eye virtual-reality images via respective left-eye and right-eye displays.

The mixed-reality computing system 1600 includes an on-board computer 1604 configured to perform various operations related to receiving, from a touch-sensitive device, control signals that are based on touch input to the touch-sensitive device, visual presentation of mixed-reality images including virtual objects via the near-eye display 1602 based on the control signals, and other operations described herein.

The mixed-reality computing system 1600 may include various sensors and related systems to provide information to the on-board computer 1604. Such sensors may include, but are not limited to, an inward-facing optical system 1610 including one or more inward facing image sensors, an outward-facing optical system 1612 including one or more outward facing image sensors, and an inertial measurement unit (IMU) 1614. The inward-facing optical system 1610 may be configured to acquire gaze tracking information from a wearer's eyes. In other implementations, a different type of gaze detector/sensor may be employed to measure one or more gaze parameters of the user's eyes.

The outward-facing optical system 1612 may be configured to measure physical environment attributes of a physical space. In one example, the outward-facing optical system 1612 includes a visible-light camera configured to collect a visible-light image of a physical space and a depth camera configured to collect a depth image of a physical space.

Data from the outward-facing optical system 1612 may be used by the on-board computer 1604 to detect movements, such as gesture-based inputs or other movements performed by a wearer or by a person or physical object in the physical space. In one example, data from the outward-facing optical system 1612 may be used to detect a wearer input performed by the wearer of the mixed-reality computing system 1600, such as a gesture. Data from the outward-facing optical system 1612 may be used by the on-board computer 1604 to determine direction/location/orientation data and/or a pose (e.g., from imaging environmental features) that enables position/motion tracking of the mixed-reality computing system 1600 in the real-world environment. In some implementations, data from the outward-facing optical system 1612 may be used by the on-board computer 1604 to construct still images and/or video images of the surrounding environment from the perspective of the mixed-reality computing system 1600.

The IMU 1614 may be configured to provide position and/or orientation data of the mixed-reality computing system 1600 to the on-board computer 1604. In one example implementation, the IMU 1614 may be configured as a three-axis or three-degree of freedom (3DOF) position sensor system. This example position sensor system may, for example, include three gyroscopes to indicate or measure a change in orientation of the mixed-reality computing system 1600 within 3D space about three orthogonal axes (e.g., roll, pitch, and yaw).

In another example, the IMU 1614 may be configured as a six-axis or six-degree of freedom (6DOF) position sensor system. Such a configuration may include three accelerometers and three gyroscopes to indicate or measure a change in location of the mixed-reality computing system 1600 along three orthogonal spatial axes (e.g., x, y, and z) and a change in device orientation about three orthogonal rotation axes (e.g., yaw, pitch, and roll). In some implementations, position and orientation data from the outward-facing optical system 1612 and the IMU 1614 may be used in conjunction to determine a position and orientation (or 6DOF pose) of the mixed-reality computing system 1600.

The mixed-reality computing system 1600 may also support other suitable positioning techniques, such as GPS or other global navigation systems. Further, while specific examples of position sensor systems have been described, it will be appreciated that any other suitable sensor systems may be used. For example, head pose and/or movement data may be determined based on sensor information from any combination of sensors mounted on the wearer and/or external to the wearer including, but not limited to, any number of gyroscopes, accelerometers, inertial measurement units, GPS devices, barometers, magnetometers, cameras (e.g., visible light cameras, infrared light cameras, time-of-flight depth cameras, structured light depth cameras, etc.), communication devices (e.g., Wi-Fi antennas/interfaces), etc.

The mixed-reality computing system 1600 may include a communication interface 1616 configured to communicate with other computing devices, such as a remote touch-sensitive device 1618. The communication interface 1616 may include any suitable communication componentry including wired and/or wireless communication devices compatible with one or more different communication protocols/standards (e.g., Wi-Fi, Bluetooth). In some implementations, the communication interface 1616 may be configured to receive, from the remote touch-sensitive device 1618, control signals that are based on touch input to the touch-sensitive device. Such control signal may enable the mixed-reality computing system 1600 to provide a mixed-reality experience in which the mixed-reality computing system 1600 visually presents virtual objects based on the touch input to the remote touch-sensitive device 1618. For example, such coordination between the remote touch-sensitive device 1618 and the mixed-reality computing system 1600 may allow for a mixed-reality experience in which interaction with the virtual objects have tactile feedback.

The on-board computer 1604 may include a logic machine and a storage machine, discussed in more detail below with respect to FIG. 17, in communication with the near-eye display 1602 and the various sensors of the mixed-reality computing system 1600.

FIG. 17 schematically shows a non-limiting implementation of a computing system 1700 that can enact one or more of the methods and processes described above. Computing system 1700 is shown in simplified form. Computing system 1700 may take the form of one or more personal computers, server computers, tablet computers, home-entertainment computers, network computing devices, gaming devices, mobile computing devices, mobile communication devices (e.g., smart phone), mixed-reality devices, touch-sensitive devices, and/or other computing devices. For example, the computing system 1700 may be a non-limiting example of the mixed-reality device 104 of FIG. 1, the mixed-reality device 132 of FIG. 8, and/or the mixed-reality computing system 1600 of FIG. 16.

Computing system 1700 includes a logic machine 1702 and a storage machine 1704. Computing system 1700 may optionally include a display subsystem 1706, input subsystem 1708, communication subsystem 1710, and/or other components not shown in FIG. 17.

Logic machine 1702 includes one or more physical devices configured to execute instructions. For example, the logic machine 1702 may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine 1702 may include one or more processors configured to execute software instructions. Additionally or alternatively, the logic machine 1702 may include one or more hardware or firmware logic machines configured to execute hardware or firmware instructions. Processors of the logic machine 1702 may be single-core or multi-core, and the instructions executed thereon may be configured for sequential, parallel, and/or distributed processing. Individual components of the logic machine 1702 optionally may be distributed among two or more separate devices, which may be remotely located and/or configured for coordinated processing. Aspects of the logic machine 1702 may be virtualized and executed by remotely accessible, networked computing devices configured in a cloud-computing configuration.

Storage machine 1704 includes one or more physical devices configured to hold instructions executable by the logic machine 1702 to implement the methods and processes described herein. When such methods and processes are implemented, the state of storage machine 1704 may be transformed—e.g., to hold different data.

Storage machine 1704 may include removable and/or built-in devices. Storage machine 1704 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 1704 may include volatile, nonvolatile, dynamic, static, read/write, read-only, random-access, sequential-access, location-addressable, file-addressable, and/or content-addressable devices.

It will be appreciated that storage machine 1704 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 1702 and storage machine 1704 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, display subsystem 1706 may be used to present a visual representation of data held by storage machine 1704. This visual representation may take the form of a graphical user interface (GUI). As the herein described methods and processes change the data held by the storage machine, and thus transform the state of the storage machine, the state of display subsystem 1706 may likewise be transformed to visually represent changes in the underlying data. Display subsystem 1706 may include one or more display devices utilizing virtually any type of technology. Such display devices may be combined with logic machine 1702 and/or storage machine 1704 in a shared enclosure, or such display devices may be peripheral display devices. As a non-limiting example, display subsystem 1706 may include the near-eye displays described above.

When included, input subsystem 1708 may comprise or interface with one or more user-input devices such as a keyboard, mouse, touch screen, active stylus, touch input device, or game controller. In some implementations, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition: a head tracker, eye tracker, accelerometer, and/or gyroscope for motion detection and/or intent recognition; as well as electric-field sensing componentry for assessing brain activity.

When included, communication subsystem 1710 may be configured to communicatively couple computing system 1700 with one or more other computing devices. Communication subsystem 1710 may include wired and/or wireless communication devices compatible with one or more different communication protocols. As non-limiting examples, the communication subsystem may be configured for communication via a wireless telephone network, or a wired or wireless local- or wide-area network. In some implementations, the communication subsystem 1710 may allow computing system 1700 to send and/or receive messages to and/or from other devices via a network such as the Internet.

In an example, a mixed-reality device, comprises a head-mounted display, a communication interface configured to wirelessly communicate with a remote touch-sensitive device, a logic machine, and a storage machine holding instructions executable by the logic machine to receive a pose of the touch-sensitive device in a physical space, receive, via the communication interface, a control signal that is based on a touch input to the touch-sensitive device, and in response to receiving the control signal, visually present, via the head-mounted display, a virtual object based on the pose of the touch-sensitive device. In this example and/or other examples, the touch-sensitive device may include a surface, and the virtual object may be visually presented based on the pose such that the virtual object appears on the surface of the touch-sensitive device. In this example and/or other examples, the storage machine may further hold instructions executable by the logic machine to visually present, via the head-mounted display, a plurality of virtual objects including the virtual object, and wherein the virtual object is selected from the plurality of virtual objects based on the control signal and in response to receiving the control signal, visually present, via the head-mounted display, the virtual object at a perceived depth different than a perceived depth of any of the other virtual objects of the plurality of virtual objects. In this example and/or other examples, the touch-sensitive device may include a surface, the plurality of virtual objects may be visually presented at a perceived depth that is different than a perceived depth of the surface, and the virtual object may be visually presented at the perceived depth of the surface. In this example and/or other examples, the control signal may characterize a touch input gesture provided to the touch-sensitive device, and the virtual object may be visually presented based on the touch gesture. In this example and/or other examples, the control signal may be a first control signal that is based on a first touch input to the touch-sensitive device, and the storage machine may further hold instructions executable by the logic machine to receive a second control signal that is based on a second touch input to the touch-sensitive device, and change an appearance of the virtual object based on the second control signal. In this example and/or other examples, changing the appearance of the virtual object may include one or more of changing a size, changing a position, and changing an orientation of the virtual object. In this example and/or other examples, the pose may be received from the touch-sensitive device via the communication interface. In this example and/or other examples, the pose may be received from a sensor system of the mixed-reality device, and the sensor system may be configured to determine a pose of the touch-sensitive device in the physical space. In this example and/or other examples, the touch-sensitive device may include a touch-sensitive display, and the storage machine may further hold instructions executable by the logic machine to identify an object visually presented via the touch-sensitive display and visually present, via the head-mounted display, the virtual object based on the object visually presented via the touch-sensitive display. In this example and/or other examples, the control signal may be a first control signal, and the storage machine may further hold instructions executable by the logic machine to receive, via the communication interface, a second control signal that is based on a touch input to the touch-sensitive device by a user in the physical space other than a wearer of the mixed-reality device, and in response to receiving the second control signal, change an appearance of the virtual object based on the second control signal. In this example and/or other examples, the control signal may be a first control signal, the virtual object may be a first virtual object, and the storage machine may further hold instructions executable by the logic machine to receive, via the communication interface, a second control signal that is based on a touch input to the touch-sensitive device by a user in the physical space other than a wearer of the mixed-reality device, and in response to receiving the second control signal, visually present, via the head-mounted display, a second virtual object based on the pose of the touch-sensitive device.

In an example, a method for operating a mixed-reality device including a head-mounted display comprises receiving a pose of a remote touch-sensitive device in a physical space, receiving, via a communication interface, a control signal that is based on a touch input to the touch-sensitive device, and in response to receiving the control signal, visually presenting, via the head-mounted display, a virtual object based on the pose of the touch-sensitive device. In this example and/or other examples, the method may further comprise visually presenting, via the head-mounted display, a plurality of virtual objects including the virtual object, and wherein the virtual object is selected from the plurality of virtual objects based on the control signal, and in response to receiving the control signal, visually presenting, via the head-mounted display, the virtual object at a perceived depth different than a perceived depth of any of the other virtual objects of the plurality of virtual objects. In this example and/or other examples, the method may further comprise receiving, via a communication interface, a second control signal that is based on a second touch input to the touch-sensitive device, and in response to receiving the second control signal, changing an appearance of the virtual object based on the second control signal. In this example and/or other examples, the touch-sensitive device may include a touch-sensitive display, and the method may further comprise identifying an object visually presented via the touch-sensitive display, and visually presenting, via the head-mounted display, the virtual object based on the object visually presented via the touch-sensitive display. In this example and/or other examples, the method may further comprise receiving, via the communication interface, a second control signal that is based on a touch input to the touch-sensitive device by a user in the physical space other than a wearer of the mixed-reality device, and in response to receiving the second control signal, visually presenting, via the head-mounted display, a second virtual object based on the pose of the touch-sensitive device.

In an example, a mixed-reality device, comprises a head-mounted display, a communication interface configured to wirelessly communicate with a remote touch-sensitive device, a logic machine, and a storage machine holding instructions executable by the logic machine to receive a pose of the touch-sensitive device in a physical space, visually present, via the head-mounted display, a virtual object having a first perceived depth based on the pose of the touch-sensitive device, receive, via the communication interface, a control signal that is based on a touch input to the touch-sensitive device by a wearer of the mixed-reality device, in response to receiving the control signal, visually present, via the head-mounted display, the virtual object with a second perceived depth based on the pose of the touch-sensitive device and different than the first perceived depth. In this example and/or other examples, the touch-sensitive device may include a surface, the first perceived depth may be different than a perceived depth of the surface, and the second perceived depth may be at the perceived depth of the surface. In this example and/or other examples, the control signal may be a first control signal that is based on a first touch input to the touch-sensitive device, and the storage machine may further hold instructions executable by the logic machine to receive a second control signal that is based on a second touch input to the touch-sensitive device, and in response to receiving the second control signal, change an appearance of the virtual object based on the second control signal.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A mixed-reality device, comprising:
a head-mounted display;
a communication interface configured to wirelessly communicate with a remote touch-sensitive device;
a logic machine; and
a storage machine holding instructions executable by the logic machine to:
receive a pose of the touch-sensitive device in a physical space;
receive, via the communication interface, a control signal that is based on a touch input to the touch-sensitive device; and
in response to receiving the control signal, visually present, via the head-mounted display, a virtual object based on the pose of the touch-sensitive device.

2. The mixed-reality device of claim 1, wherein the touch-sensitive device includes a surface, and wherein the virtual object is visually presented based on the pose such that the virtual object appears on the surface of the touch-sensitive device.

3. The mixed-reality device of claim 1, wherein the storage machine further holds instructions executable by the logic machine to:
visually present, via the head-mounted display, a plurality of virtual objects including the virtual object, and wherein the virtual object is selected from the plurality of virtual objects based on the control signal; and
in response to receiving the control signal, visually present, via the head-mounted display, the virtual object at a perceived depth different than a perceived depth of any of the other virtual objects of the plurality of virtual objects.

4. The mixed-reality device of claim 3, wherein the touch-sensitive device includes a surface, wherein the plurality of virtual objects are visually presented at a perceived depth that is different than a perceived depth of the surface, and wherein the virtual object is visually presented at the perceived depth of the surface.

5. The mixed-reality device of claim 1, wherein the control signal characterizes a touch input gesture provided to the touch-sensitive device, and wherein the virtual object is visually presented based on the touch gesture.

6. The mixed-reality device of claim 1, wherein the control signal is a first control signal that is based on a first touch input to the touch-sensitive device, and wherein the storage machine further holds instructions executable by the logic machine to:
receive a second control signal that is based on a second touch input to the touch-sensitive device; and
change an appearance of the virtual object based on the second control signal.

7. The mixed-reality device of claim 6, wherein changing the appearance of the virtual object includes one or more of changing a size, changing a position, and changing an orientation of the virtual object.

8. The mixed-reality device of claim 1, wherein the pose is received from the touch-sensitive device via the communication interface.

9. The mixed-reality device of claim 1 wherein the pose is received from a sensor system of the mixed-reality device, the sensor system configured to determine a pose of the touch-sensitive device in the physical space.

10. The mixed-reality device of claim 9, wherein the touch-sensitive device includes a touch-sensitive display wherein the storage machine further holds instructions executable by the logic machine to:
identify an object visually presented via the touch-sensitive display; and
visually present, via the head-mounted display, the virtual object based on the object visually presented via the touch-sensitive display.

11. The mixed-reality device of claim 1, wherein the control signal is a first control signal, and wherein the storage machine further holds instructions executable by the logic machine to:
receive, via the communication interface, a second control signal that is based on a touch input to the touch-sensitive device by a user in the physical space other than a wearer of the mixed-reality device; and
in response to receiving the second control signal, change an appearance of the virtual object based on the second control signal.

12. The mixed-reality device of claim 1, wherein the control signal is a first control signal, wherein the virtual object is a first virtual object, and wherein the storage machine further holds instructions executable by the logic machine to:
receive, via the communication interface, a second control signal that is based on a touch input to the touch-sensitive device by a user in the physical space other than a wearer of the mixed-reality device; and
in response to receiving the second control signal, visually present, via the head-mounted display, a second virtual object based on the pose of the touch-sensitive device.

13. A method for operating a mixed-reality device including a head-mounted display, the method comprising:
receiving a pose of a remote touch-sensitive device in a physical space;
receiving, via a communication interface, a control signal that is based on a touch input to the touch-sensitive device; and
in response to receiving the control signal, visually presenting, via the head-mounted display, a virtual object based on the pose of the touch-sensitive device.

14. The method of claim 13, further comprising:
visually presenting, via the head-mounted display, a plurality of virtual objects including the virtual object, and wherein the virtual object is selected from the plurality of virtual objects based on the control signal; and
in response to receiving the control signal, visually presenting, via the head-mounted display, the virtual object at a perceived depth different than a perceived depth of any of the other virtual objects of the plurality of virtual objects.

15. The method of claim 13, further comprising:
receiving, via a communication interface, a second control signal that is based on a second touch input to the touch-sensitive device; and
in response to receiving the second control signal, changing an appearance of the virtual object based on the second control signal.

16. The method of claim 13, wherein the touch-sensitive device includes a touch-sensitive display, and wherein the method further comprises:
identifying an object visually presented via the touch-sensitive display; and
visually presenting, via the head-mounted display, the virtual object based on the object visually presented via the touch-sensitive display.

17. The method of claim 13, further comprising:
receiving, via the communication interface, a second control signal that is based on a touch input to the touch-sensitive device by a user in the physical space other than a wearer of the mixed-reality device; and
in response to receiving the second control signal, visually presenting, via the head-mounted display, a second virtual object based on the pose of the touch-sensitive device.

18. A mixed-reality device, comprising:
a head-mounted display;
a communication interface configured to wirelessly communicate with a remote touch-sensitive device;
a logic machine; and
a storage machine holding instructions executable by the logic machine to:
receive a pose of the touch-sensitive device in a physical space;
visually present, via the head-mounted display, a virtual object having a first perceived depth based on the pose of the touch-sensitive device;
receive, via the communication interface, a control signal that is based on a touch input to the touch-sensitive device by a wearer of the mixed-reality device;
in response to receiving the control signal, visually present, via the head-mounted display, the virtual object with a second perceived depth based on the pose of the touch-sensitive device and different than the first perceived depth.

19. The mixed-reality device of claim 18, wherein the touch-sensitive device includes a surface, wherein the first perceived depth is different than a perceived depth of the surface, and wherein the second perceived depth is at the perceived depth of the surface.

20. The mixed-reality device of claim 18, wherein the control signal is a first control signal that is based on a first touch input to the touch-sensitive device, and wherein the storage machine further holds instructions executable by the logic machine to:
receive a second control signal that is based on a second touch input to the touch-sensitive device; and
in response to receiving the second control signal, change an appearance of the virtual object based on the second control signal.
